(19) United States
(12) Patent Application Publication
(10) Pub. No.: US 2017/0051194 A1
(43) Pub. Date: Feb. 23, 2017

(54) FLUORO-INORGANICS FOR ACIDIFICATION OR NEUTRALIZATION OF WATER SYSTEMS

(71) Applicant: Ecolab USA Inc., St. Paul, MN (US)

(72) Inventors: Anthony G. Sommese, Wheaton, IL (US); Jasbir S. Gill, Naperville, IL (US); Thomas M. Miller, Aurora, IL (US)

(21) Appl. No.: 15/237,920

(22) Filed: Aug. 16, 2016

Related U.S. Application Data
(60) Provisional application No. 62/206,658, filed on Aug. 18, 2015.

(51) Int. Cl. C09K 8/54; C23F 11/04

(52) U.S. Cl. CPC C09K 8/54; C23F 11/04; C09K 2208/32

(57) ABSTRACT

The present invention generally relates to methods for reducing the pH of aqueous mixtures with the advantage of preventing formation of deposits and scales on internal surfaces in contact with the aqueous systems. These methods also that the advantages that they reduce pH with less corrosion or metal loss of the internal surface as compared with a conventional strong acid used to reduce the pH in such systems. The methods use an acid composition comprising a salt of a nitrogen base having a fluoro inorganic anion.

### CROSS-REFERENCE TO RELATED APPLICATION

This application claims priority to U.S. Provisional Patent Application Ser. No. 62/206,658 filed on Aug. 18, 2015, the disclosure of which is incorporated herein by reference in its entirety.

### FIELD OF THE INVENTION

The present invention generally relates to methods for reducing the pH of aqueous mixtures with the advantage of preventing formation of deposits and scales on internal surfaces in contact with the aqueous systems. These methods also have the advantages that they reduce pH with less corrosion or metal loss of the internal surface as compared with a conventional strong acid used to reduce the pH in such systems. The methods use an acid composition comprising a salt of a nitrogen base having a fluoro inorganic anion.

### BACKGROUND OF THE INVENTION

Traditionally, mineral acids such as hydrochloric acid or inhibited hydrochloric acid are used to acidify or neutralize high alkaline water systems. The use of mineral acids can cause corrosion issues of the pipelines and other equipment. Mineral acids also cause metal loss during cleaning of aqueous systems fouled with deposits and scales in systems contacting the aqueous mixture; the system can be a heat exchangers, cooling or heating system, a pipeline, a water distribution system, or an oil and geothermal well. Some of the waters that may have very high alkalinity must be neutralized prior to their use in order to prevent deposition. Such waters neutralized with mineral acids will subsequently become very corrosive and cause metal loss due the presence counter ions of the neutralizing mineral acid.

Scale deposits can occur in many industrial systems. For example, carbonate based scale deposits are a problem in some evaporators, heat exchangers, and cooling coils. These scales can clog flow lines, form oily sludges, and form emulsions that are hard to break.

Silicate-based deposits can occur in many industrial systems. For example, silicate-based deposits are also a problem in some evaporators, heat exchangers, geothermal systems and cooling coils. The presence of silica/silicate deposits can significantly reduce system thermal efficiency and productivity, increase operating/maintenance costs, and in some cases lead to equipment failure. Cooling/heating systems, steam generators and evaporators are especially prone to silicate deposits due to operation at elevated temperatures, pH, and increased cycles of concentration (COC).

Chemical treatment programs can be used to minimize deposits, but all the system described above can become fouled over time and cleaning is in order. Options for cleaning are chemical in-situ programs or mechanical.

As a result of significant silica/silicate deposit formation that can occur in unit operations such as evaporators, opportunities exist to improve system operations by using an effective in-situ chemical cleaning program. One option to deal with declining performance of various evaporators due to scale deposits is to implement a chemical wash. Chemistries previously used have been commodity acid or caustic which usually are not fully effective for dissolving all deposits and scales. Those cleaners can be very hazardous to both equipment and personnel. Hydrofluoric acid is often the only acid which could effectively clean silica based deposits and it is extremely hazardous. Further, those acids are also known to be corrosive to surfaces. If a chemical wash does not effectively dissolve tenacious deposits, then mechanical cleaning is performed. Mechanical cleaning can be useful for removing flaky deposits but may only polish a more tenacious deposit without removing it and leading to a continued deposition of layers over time. Mechanical cleaning is also very time consuming, can only be done in easy to reach areas only, expensive (e.g., for waste removal/labor costs), and can result in significant lost production.

Therefore, there remains a need to employ improved acids for reducing pH in aqueous systems that are less corrosive to metal surfaces.

### SUMMARY OF THE INVENTION

One aspect of the invention is a method for reducing the pH of an aqueous system by contacting the surface of a piece of equipment with an acid composition, wherein the acid composition comprises a salt of a nitrogen base having a fluoro inorganic anion or boron ion.

Another aspect of the invention is an acid composition comprising a surfactant, a corrosion inhibitor, and a chelating agent.

Other objects and features will be in part apparent and in part pointed out hereinafter.

### BRIEF DESCRIPTION OF THE DRAWINGS

FIG. 1 is a graph of NMC average vs. pH of various compositions A, D, and F with inhibited I.

### DESCRIPTION OF THE PREFERRED EMBODIMENTS

The present invention is directed towards reducing the pH of an aqueous system comprising contacting an acid composition with an internal surface of a piece of equipment, or contacting an acid composition with an aqueous mixture that contacts an internal surface of a piece of equipment wherein the acid composition comprises a salt of a nitrogen base having a fluoro inorganic anion. These methods provide reduced corrosion of metal surfaces, less loss of metal atoms, and reduce the need to mechanically clean the affected surfaces of the system. In addition, the compositions are less hazardous than many alternative acids used to reduce pH in aqueous systems. Further, the compositions are particularly effective for preventing carbonate-, oxalate-, phosphate, iron, manganese, sulfate-, and/or silica-based scales on equipment including pipes, tanks, steam generators, heating and cooling exchangers, and evaporators.

The produced water can be highly concentrated in carbonates, oxalates, sulfates, and silicates that can cause the pH of the aqueous mixture to increase. During the recycling process, the produced water is passed through cooling towers and evaporators where high quality feedwater is produced. The alkalinity and counter ions, i.e. Ca, to carbonates and sulfates, other scale forming ions as well as corrosive ions such as chlorides are also concentrated, which are prone to forming scales and cause corrosion. Traditionally, acids are used to neutralize this alkalinity but this is done at the risk of exposing the surfaces to acids which are known to be corrosive by their virtue as well as adding more corrosive ions such as chlorides and sulfates. Using the current invention, the alkalinity can be neutralized, CO₂ can be released, and the risk of corrosion is decreased.

The acid composition comprises a salt of a nitrogen base having a fluoro inorganic anion.

The fluoro inorganic anion can comprise a borate ion, a phosphate ion, or a combination thereof. Preferably, the fluoro inorganic anion comprises a borate ion.

The fluoro inorganic anion can comprise tetrafluoroborate, hexafluorophosphate, or a combination thereof. Additionally, the hydrolysis products of tetrafluoroborate and hexafluorophosphate that contain fluorine atoms can also be used.

Preferably, the fluoro inorganic anion of the composition comprises tetrafluoroborate.

The compositions can have the fluoro inorganic anion comprise tetrafluoroborate and the nitrogen base comprise urea and the molar ratio of urea to tetrafluoroboric acid used to prepare the salt is 1:3 to 5:1, preferably 1:2 to 3:1. The nitrogen base (e.g., urea) can react with the fluoro inorganic acid (e.g., fluoroboric acid) to form the salt of a nitrogen base having a fluoro inorganic anion (e.g., urea tetrafluoroborate). However, the relative amounts and/or concentrations of the fluoro inorganic acid component and base component in the compositions of the present invention can vary widely, depending on the desired function of the composition and/or the required cleaning activity.

The concentration of the salt of a nitrogen base having a fluoro inorganic anion in the composition can be from about 50 wt. % to about 90 wt. %, from about 50 wt. % to about 80 wt. %, from about 50 wt. % to about 70 wt. %, from about 50 wt. % to about 60 wt. %, from about 60 wt. % to about 90 wt. %, from about 60 wt. % to about 80 wt. %, from about 60 wt. % to about 70 wt. %, from about 70 wt. % to about 90 wt. %, from about 80 wt. % to about 90 wt. %, or from about 70 wt. % to about 80 wt. %.

The concentration of the salt of a nitrogen base having a fluoro inorganic anion can be used as a neutralizing agent at a concentration from about 5 wt. % to about 30 wt. %, from about 5 wt. % to about 25 wt. %, from about 5 wt. % to about 20 wt. %, from about 5 wt. % to about 15 wt. %, from about 10 wt. % to about 30 wt. %, from about 10 wt. % to about 25 wt. %, from about 10 wt. % to about 20 wt. %, from about 10 wt. % to about 15 wt. %, from about 15 wt. % to about 30 wt. %, from about 15 wt. % to about 25 wt. %, or from about 15 wt. % to about 20 wt. %, based on the total weight of the neutralizing composition.

For continuous pH neutralization, the salt of a nitrogen base having a fluoro inorganic anion can be used as a neutralizing agent at a concentration from about 5 ppm to about 200 ppm, from about 5 ppm to about 150 ppm, from about 5 ppm to about 100 ppm, from about 10 ppm to about 200 ppm, from about 10 ppm to about 150 ppm, or from about 10 ppm to about 100 ppm, based on the total weight of the solution that the neutralization composition is added to.

Further, the weight ratios and/or concentrations utilized can be selected to achieve a composition and/or system having the desired cleaning and health and safety characteristics.

The nitrogen base can be urea, biuret, an alkyl urea, an alkanolamine, an alkylamine, a dialkylamine, a trialkylamine, an alkyltetramine, a polyamine, an acrylamide, a polyacrylamide, a vinyl pyrrolidone, a polyvinyl pyrrolidone, or a combination thereof.

The salt of a nitrogen base having a fluoro inorganic anion is disclosed in U.S. Pat. Nos. 8,389,453 and 8,796,195 and available commercially from Nalco-Champion as Product No. EC6697A.

The compositions of the present invention can be provided in conjunction with a fluid or an aqueous medium and can be provided in a ready-to-use form or can be provided as separate agents and the composition can be prepared at the site of the treatment. Depending on the nature of use and application, the composition can be in form of a concentrate containing a higher proportion of the salt of nitrogen base having a fluoro inorganic anion, the concentrate being diluted with water or another solvent or liquid medium or other components such as the antifoaming agent, organic inhibitor of silica or silicate deposits, corrosion inhibitor, or surfactant before or during use. Such concentrates can be formulated to withstand storage for prolonged periods and then diluted with water in order to form preparations which remain homogeneous for a sufficient time to enable them to be applied by conventional methods. After dilution, such preparations may contain varying amounts of the acid composition, depending upon the intended purpose or end-use application.

The aqueous system can be a produced water, a surface water, a ground water, a feedwater, or a combination thereof.

The aqueous system can have a basic pH (i.e., a pH>7).

The acid composition can reduce corrosion of the internal surface of the piece of equipment as compared to the same method using a conventional acid composition (e.g., hydrochloric acid, hydrofluoric acid, sulfuric acid, etc.). A conventional acid composition can comprise a mineral acid composition.

The acid composition can reduce metal loss from the internal surface of the piece of equipment as compared to the same method using a conventional acid composition (e.g., hydrochloric acid, hydrofluoric acid, sulfuric acid, organic acids, etc.).

The acid composition can further comprise sodium chlorite/chlorate, and an additional acid. This acid composition can disinfect the aqueous system.

The internal surface in contact with the acid composition is an internal surface of a piece of equipment. This piece of equipment could be a steam generator, an evaporator, a heat exchanger, a cooling coil, a tank, a sump, a containment vessel, a pump, a distributor plate, or a tube bundle.

The piece of equipment could be a boiler, a steam generator, an evaporator, a heat exchanger, a tube bundle, a cooling coil, a chiller, a tank, a sump, a containment vessel, a pump, a distributor plate, a geothermal injection well, a geothermal production well, a geothermal steam separator, or a binary geothermal unit.

The piece of equipment whose internal surface is cleaned in the method described herein could also be a pipe, a drain line, or a fluid transfer line.

The piece of equipment could be a geothermal injection well, a geothermal production well, a geothermal steam separator, or a binary geothermal unit.

Preferably, the piece of equipment cleaned using the methods described herein is an evaporator or a steam generator.

The evaporator or steam generator can be used in a geothermal surface system, a thermal recovery system, a sugar production system, or an ethanol production system.

The thermal recovery system can be a steam-assisted gravity drainage system, a steam flood system, or a cyclic steam stimulation system.

When the acid composition is used in a sugar production system, the acid composition inhibits or removes deposits including oxalate, silica, phosphate, or carbonate deposits.

When the acid composition is used in a geothermal surface system, the acid composition inhibits or removes deposits including silica, carbonate, or sulfide deposits.

The composition can further comprise one or more additional components including but not limited to a corrosion inhibitor, a solvent, an asphaltene inhibitor, an additional paraffin inhibitor, a scale inhibitor, an emulsifier, a dispersant, an emulsion breaker, a gas hydrate inhibitor, a biocide, a pH modifier, and a surfactant. A composition of the invention can comprise from 0 to 10 percent by weight of one or more of these additional components, based on total weight of the composition.

The acid composition can also comprise a corrosion inhibitor. When the acid composition comprises a corrosion inhibitor, the corrosion inhibitor is present in an amount as follows based on the total concentration of the aqueous mixture to be treated. Thus, the corrosion inhibitor can be used at a concentration of from about 1 ppm to about 1000 ppm, from about 1 ppm to about 800 ppm, from about 1 ppm to about 600 ppm, from about 1 ppm to about 500 ppm, from about 1 ppm to about 400 ppm, from about 1 ppm to about 200 ppm, from about 5 ppm to about 1000 ppm, from about 5 ppm to about 800 ppm, from about 5 ppm to about 600 ppm, from about 5 ppm to about 500 ppm, from about 5 ppm to about 400 ppm, or from about 5 ppm to about 200 ppm.

Suitable corrosion inhibitors for inclusion in the compositions include, but are not limited to, alkyl, hydroxyalkyl, alkylaryl, arylalkyl or arylamine quaternary salts; mono or polycyclic aromatic amine salts; imidazoline derivatives; mono-, di-or trialkyl or alkylaryl phosphate esters; phosphate esters of hydroxylamines; phosphate esters of polyols; and monomeric or oligomeric fatty acids.

Suitable alkyl, hydroxyalkyl, alkylaryl arylalkyl or arylamine quaternary salts include those alkylaryl, arylalkyl and arylamine quaternary salts of the formula [N⁺R^{5a}R^{6a}R^{7a}R^{8a}][X⁻] wherein R^{5a}, R^{6a}, R^{7a}, and R^{8a} contain one to 18 carbon atoms, and X is Cl, Br or I. For these quaternary salts, R^{5a}, R^{6a}, R^{7a}, and R^{8a} are each independently selected from the group consisting of alkyl (e.g., C₁-C₁₈ alkyl), hydroxyalkyl (e.g., C₁-C₁₈ hydroxyalkyl), and arylalkyl (e.g., benzyl). The mono or polycyclic aromatic amine salt with an alkyl or alkylaryl halide include salts of the formula [N⁺R^{5a}R^{6a}R^{7a}R^{8a}][X⁻] wherein R^{5a}, R^{6a}, R^{7a}, and R^{8a} contain one to 18 carbon atoms, and X is Cl, Br or I.

Suitable quaternary ammonium salts include, but are not limited to, tetramethyl ammonium chloride, tetraethyl ammonium chloride, tetrapropyl ammonium chloride, tetrabutyl ammonium chloride, tetrahexyl ammonium chloride, tetraoctyl ammonium chloride, benzyltrimethyl ammonium chloride, benzyltriethyl ammonium chloride, phenyltrimethyl ammonium chloride, phenyltriethyl ammonium chloride, cetyl benzyldimethyl ammonium chloride, hexadecyl trimethyl ammonium chloride, dimethyl alkyl benzyl quaternary ammonium compounds, monomethyl dialkyl benzyl quaternary ammonium compounds, trimethyl benzyl quaternary ammonium compounds, and trialkyl benzyl quaternary ammonium compounds, wherein the alkyl group can contain between about 6 and about 24 carbon atoms, about 10 and about 18 carbon atoms, or about 12 to about 16 carbon atoms. Suitable quaternary ammonium compounds (quats) include, but are not limited to, trialkyl, dialkyl, dialkoxy alkyl, monoalkoxy, benzyl, and imidazolinium quaternary ammonium compounds, salts thereof, the like, and combinations thereof. The quaternary ammonium salt can be an alkylamine benzyl quaternary ammonium salt, a benzyl triethanolamine quaternary ammonium salt, or a benzyl dimethylaminoethanolamine quaternary ammonium salt.

The corrosion inhibitor can be a quaternary ammonium or alkyl pyridinium quaternary salt such as those represented by the general formula:

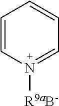

wherein R^{9a} is an alkyl group, an aryl group, or an arylalkyl group, wherein said alkyl groups have from 1 to about 18 carbon atoms and B is Cl, Br or I. Among these compounds are alkyl pyridinium salts and alkyl pyridinium benzyl quats. Exemplary compounds include methyl pyridinium chloride, ethyl pyridinium chloride, propyl pyridinium chloride, butyl pyridinium chloride, octyl pyridinium chloride, decyl pyridinium chloride, lauryl pyridinium chloride, cetyl pyridinium chloride, benzyl pyridinium and an alkyl benzyl pyridinium chloride, preferably wherein the alkyl is a C₁-C₆ hydrocarbyl group. The corrosion inhibitor can include benzyl pyridinium chloride.

The corrosion inhibitor can also be an imidazoline derived from a diamine, such as ethylene diamine (EDA), diethylene triamine (DETA), triethylene tetraamine (TETA) etc. and a long chain fatty acid such as tall oil fatty acid (TOFA). Suitable imidazolines include those of formula:

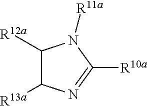

wherein R^{12a} and R^{13a} are independently a C₁-C₆ alkyl group or hydrogen, R^{11a} is hydrogen, C₁-C₆ alkyl, C₁-C₆ hydroxyalkyl, or C₁-C₆ arylalkyl, and R^{10a} is a C₁-C₂₀ alkyl or a C₁-C₂₀ alkoxyalkyl group. Preferably, R^{11a}, R^{12a} and R^{13a} are each hydrogen and R^{10a} is the alkyl mixture typical in tall oil fatty acid (TOFA).

The corrosion inhibitor compound can further be an imidazolinium compound of the following formula:

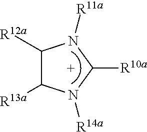

wherein R^{12a} and R^{13a} are independently a C₁-C₆ alkyl group or hydrogen, R^{11a} and R^{14a} are independently hydrogen, C₁-C₆ alkyl, C₁-C₆ hydroxyalkyl, or C₁-C₆ arylalkyl, and R¹⁰ is a C₁-C₂₀ alkyl or a C₁-C₂₀ alkoxyalkyl group.

Suitable mono-, di-and trialkyl as well as alkylaryl phosphate esters and phosphate esters of mono, di, and triethanolamine typically contain between from 1 to about 18 carbon atoms. Preferred mono-, di-and trialkyl phosphate esters, alkylaryl or arylalkyl phosphate esters are those prepared by reacting a C₃-C₁₈ aliphatic alcohol with phosphorous pentoxide. The phosphate intermediate interchanges its ester groups with triethyl phosphate with triethylphosphate producing a more broad distribution of alkyl phosphate esters. Alternatively, the phosphate ester may be made by admixing with an alkyl diester, a mixture of low molecular weight alkyl alcohols or diols. The low molecular weight alkyl alcohols or diols preferably include C₆ to C₁₀ alcohols or diols. Further, phosphate esters of polyols and their salts containing one or more 2-hydroxyethyl groups, and hydroxylamine phosphate esters obtained by reacting polyphosphoric acid or phosphorus pentoxide with hydroxylamines such as diethanolamine or triethanolamine are preferred.

The corrosion inhibitor compound can further be a dicarboxylic acid, a monomeric fatty acid, or an oligomeric fatty acid. Preferred are C₁₄-C₂₂ saturated and unsaturated fatty acids as well as dimer, trimer and oligomer products obtained by polymerizing one or more of such fatty acids.

The corrosion inhibitor can be a zinc phosphino succinic oligomer, or a mixture of zinc phosphino succinic oligomers.

The corrosion inhibitor can be an azole such tolyltriazole, benzotriazole, an alkoxy-substituted azole (e.g., alkoxybenzotriazole), and the like.

The acid composition can also comprise a scale inhibitor. When the acid composition comprises a scale inhibitor, the scale inhibitor is present in an amount as follows based on the total concentration of the aqueous mixture to be treated. The scale inhibitor can be used at a concentration of from about 1 ppm to about 200 ppm, from about 1 ppm to about 150 ppm, from about 1 ppm to about 100 ppm, from about 1 ppm to about 50 ppm, from about 5 ppm to about 200 ppm, from about 5 ppm to about 150 ppm, from about 5 ppm to about 100 ppm, or from about 5 ppm to about 50 ppm.

Suitable scale inhibitors include, but are not limited to, phosphates, phosphate esters, phosphoric acids, phosphonates, phosphonic acids, polyacrylamides, salts of acrylamido-methyl propane sulfonate/acrylic acid copolymer (AMPS/AA), phosphinated maleic copolymer (PHOS/MA), and salts of a polymaleic acid/acrylic acid/acrylamido-methyl propane sulfonate terpolymer (PMA/AMPS).

The method for cleaning the internal surface of the piece of equipment can be carried out when the equipment is on-line or off-line.

When the piece of equipment is on-line, the acid composition is from about 65 to about 85% active acid concentration in the acid composition and is fed to the system at from about 10 to about 100 ppm of active acid based on the aqueous system volume. Similarly it can be added to other aqueous systems with a chemical feed pump. When the piece of equipment is off-line, the acid composition comprises from about 10 wt. % to about 20 wt. % acid, preferably about 15 wt. % acid in an aqueous mixture and is added to the feed line to directly contact the internal surface of the equipment desired to be cleaned.

The typical operating characteristics for an evaporator system are detailed in Table 1.

TABLE 1
Typical Operating Characteristics (approx.)

| | Smaller | Larger |
|---|---|---|
| Parameter | System | System |
| Feedwater Flow | 250 | 300 |
| (m³/hr) | | |
| Tube Bundle | 12,000 | 12,000 |
| Surface Area (m²) | | |
| Feedwater Temp. | 80 | 80 |
| (° C.) | | |
| Sump Temp. (° C.) | 105 | 105 |
| Total Distillate | 244-245 | 293-294 |
| (m³/hr) | | |
| Blowdown Rate | ~5-6 | ~6-7 |
| (m³/hr) | | |
| Total Cycles of | 45-55 | 45-55 |
| Concentration | | |
| (target) | | |

Falling film MVC evaporators have high heat transfer characteristics and efficiency compared to other evaporator designs (Heins, W. (2008). Technical Advancements in SAGD Evaporative Produced Water Treatment, International Water Conference in San Antonio, Tex., October 26-30, IWC-08-55). A high heat transfer coefficient is required to effectively evaporate the water and increase the temperature (ΔT˜27° C. at application site) to produce high quality feedwater. Along with the evaporative process, the concentration of substances present in the feedwater can be cycled up as high as 45-55 times their initial concentration. The combination of higher temperature and higher concentrations of inorganic and organic substances increases the probability that the inversely soluble and particulate substances will deposit on wetted portions of evaporator system.

The average evaporator feedwater quality for five months of operation and the feedwater quality at 45 total cycles of concentration are shown in Table 2. The inorganic portion of water chemistry was measured by inductively-coupled plasma (ICP) spectroscopy.

TABLE 2
Evaporator Feedwater Quality and Impact of Cycles of Concentration

Concentration
(mg/L)

| | | @ 45 |
|---|---|---|
| Chemistry^{a} | Feedwater | cycles^{b} |
| Aluminum (as Al) | 0.23 | 10.4 |
| Calcium (as Ca) | 2.24 | 101 |
| Magnesium (as Mg) | 0.58 | 26.1 |
| Ca + Mg Hardness | 8.0 | 360 |
| (as CaCO₃) | | |
| Silica (as SiO₂) | 244 | 10,980 |
| TOC | 760 | 34,200 |

^{a}Additional ions at high concentrations in the feedwater are boron ~29 mg/L, Na⁺ ~690 mg/L, Cl⁻ ~210 mg/L, and sulfate ~280 mg/L
^{b}Assumes 100% Transport, deposit formation will result in lower concentrations measured in evaporator blowdown.

Having described the invention in detail, it will be apparent that modifications and variations are possible without departing from the scope of the invention defined in the appended claims.

### EXAMPLES

The following non-limiting examples are provided to further illustrate the present invention.

### Example 1

### Deposit Composition

The chemical composition of four deposits was determined by a standard composition analysis of X-ray fluorescence for elemental composition, organics concentration by C/H/N/S elemental analysis, and the concentrations of organics/water of hydration and other volatile substances by heating to 925° C. for a defined period of time. The results are shown in Table 3.

TABLE 3
Chemical composition of deposits.

| Chemistry | Deposit #1 | Deposit #2 | Deposit #3 | Deposit #4 |
|---|---|---|---|---|
| Silica (as SiO₂) | 56% | 49% | 56% | 51% |
| Calcium (as CaO) | 15% | 41% | 11% | 5% |
| Sodium | 4% | 5% | 7% | 3% |
| (as Na₂O) | | | | |
| Aluminum | <0.5% | <0.5% | 1% | 3% |
| (Al₂O₃) | | | | |
| Chlorine (as Cl) | 3% | <0.5% | 2% | not detected |
| Magnesium | 2% | 1% | 1% | 8% |
| (as MgO) | | | | |
| Potassium (K₂O) | <0.5% | <0.5% | 4% | 2% |
| Sulfur (as SO₃) | <0.5% | <0.5% | <0.5% | 2% |
| Iron (as Fe₂O₃) | <0.5% | <0.5% | 1% | <0.5% |
| Organics | <0.5% | <0.5% | 5% | 14% |
| Loss at 925° C.^{a} | 20% | 2% | 17% | 25% |
| Application -> | Evaporator | Once-Thru | Evaporator | Evaporator |
| | | HRSG | | |

^{a}Likely due to water of hydration and also includes organics

### Example 2

### Corrosion Rate Determination with Bar Style Coupons

Mild steel coupons (Nalco Product No. P5035A) were used to evaluate the corrosion rates of various acids and acids in combination with corrosion inhibitors. The test acids were prepared as a 5, 15, or 25 wt. % solution in distilled water. The corrosion inhibitors were prepared as a 0.5, 1.0, 2.0 or 3.0 wt. % solution in distilled water. The test fluid (about 450 mL) was added to a wide mouth plastic bottle (500 mL). Various amounts of corrosion inhibitor(s) were added to the jar, the jar was capped, and the jar was shaken to mix the two liquids. Three mild steel coupons were attached to a perforated cap by nonmetallic attachments and height adjusted to be suspended below the surface of the fluid. The coupons were evenly spaced around the cap so they did not contact one another. The perforated cap and coupons were installed on the wide mouth jar, and the jar was placed in a circulating water bath. The circulating water bath was set at 65, 75, or 90° C. A plastic tube connected to an air line was then inserted through the center hole of the cap. The air flow was set at between 5 to 10 mL/minute.

Coupons were removed, one after each time point (6, 24, and 48 hours), cleaned with a soft plastic scrubber, and rinsed once with distilled water and twice with acetone to dry. Coupons were then placed in a desiccator to equilibrate to temperature.

Following cleaning and temperature equilibration the coupons were weighed and the corrosion rate was calculated. The corrosion rate was calculated from weight loss of the coupon, exposure time, and surface area of the coupon.

The acids tested were urea tetrafluoroborate (available commercially from Nalco-Champion as Product No. EC6697/R-50975, identified as composition A hereinafter), urea sulfate (available commercially from Vitech International Inc. as Product A-85, identified as composition B hereinafter), modified urea tetrafluoroborate (available commercially from Vitech International, Inc. as Product APW, identified as composition C hereinafter), urea hydrochloride (available commercially from Vitech International Inc. as Product BSJ-I, identified as composition D hereinafter), urea methanesulfonate (available commercially from Vitech International Inc. as Product M5, identified as composition E hereinafter), and hydrochloric acid (identified as composition F hereinafter).

The acid corrosion inhibitors tested were blends of a quaternary amine, a fatty acid, imidazoline, and an alkyl-derivatized imidazoline, phosphate organic phosphates, and zinc or their blends commercially available from Nalco champion as products, EC1509A, EC9374A, ASP542, 3DT129, and the like.

### Example 3

### Corrosion Rate Titration Study

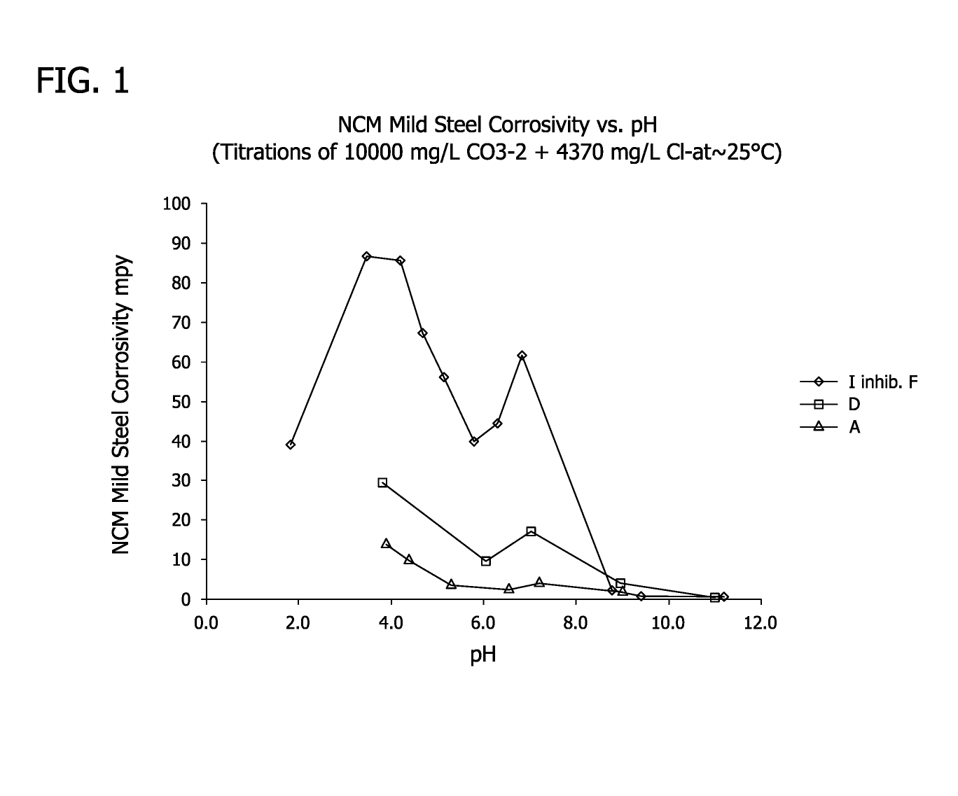

Various neat acids were used in a titration study to evaluate their corrosion rates. A test fluid was prepared by dissolving sodium carbonate (35.34 g) and sodium chloride (14.4 g) in distilled water (2 L). This test fluid was then placed in a 5 L beaker with a magnetic stirring bar. The stirring rate was adjusted to ensure good mixing without introducing bubbles into the test fluid. A Nalco Corrosion Monitor (NCM) mild steel probe and a pH probe were installed in the fluid. The probes were then connected to a 3D TRASAR® controller to record the data. Aliquots of a neat acid were added to the test fluid and readings were obtained. The titration was continued until the pH of the fluid was beyond the range of interest. The neat acids used in this trial were composition A, composition F (inhibited hydrochloric acid, commercially available from Nalco Champion as N2560), and composition D (urea-hydrofuoride hydrofluoride, commercially available from Nalco Champion as Product DC14, identified as composition J hereinafter). Results from this study are shown in FIG. 1.

It should be noted that the NCM probe reading took about nine minutes, so titration aliquots required at least 20 minutes for equilibration.

### Example 4

### Corrosion Rate Titration Study

Another set of corrosion rate titrations was conducted in as described in Example 3 with the change that 35.3 g of sodium carbonate and 14.4 g of sodium chloride was dissolved in 2 L of distilled water. The pH was adjusted to pH 4 with acid.

### Example 5

### 48-Hour Corrosion Rate Titration Study

In a third example of corrosion rate titration studies, 176.7 g of sodium carbonate and 72.0 g of sodium chloride were dissolved in 10 L of distilled water. Coupons were pretreated with 10× product for 72 hours at 90° C. Approximately 8 L of the prepared solution was titrated with acid to a pH between 3.8 and 4.0, to eliminate all CO₂, diluted to 9 L and allowed to equilibrate overnight at 40° C. Following equilibration, the solution was further diluted to 10 Land the temperate was raised to 90° C. Coupons and pH and NCM probes were installed in the test cell. Acids used in this study include compositions D and E. Corrosion inhibitors used in this study include blend of organic quaternary amines, tall oil, fatty acid, and the like commercially available from Nalco Champion as Product TX16010, identified as composition K hereinafter) Four test conditions were setup, D, F, D with K and D with L. After 48 hours, the coupons were removed, cleaned, and weighed as described in Example 2.

### Example 6

### Hybrid Corrosion Rate Determination Using Bar Style Coupons and Composition D

A hybrid corrosion rate study of the previously described examples was performed. A test fluid was prepared using 8.8 g of sodium carbonate, 3.6 g of sodium chloride, and 27.153 g of composition D were dissolved in 500 mL of distilled water. The pH of the equilibrated solution was 3.06. The solution was added to a wide mouth plastic bottle and the coupons (Nalco P5035A) were attached evenly around a perforated cap. The bottle was capped and an air line was attached with a flow rate of 5 mL/minute with 100% humidity. The study was conducted a temperature of 75° C. The corrosion rate was measured in millimeters per year (mmpy) and mils per year (mpy). Low corrosion rates show products having better performance.

TABLE 4
Corrosion rate of composition D.

| | |
|---|---|
| Weight | Corrosion Rate |

| Coupon | Composition | Loss (g) | mmpy | mpy |
|---|---|---|---|---|
| 1 | D | 0.005 | 0.43 | 17 |
| 2 | D | 0.0411 | 0.88 | 35 |
| 3 | D | 0.0484 | 0.52 | 20 |

### Example 7

### Hybrid Corrosion Rate Determination Using Bar Style Coupons and Composition A

A hybrid corrosion rate study was conducted in as described in Example 5 with the exception that 40.0046 g of composition A was used in the test fluid. The pH of the solution was 3.75.

TABLE 5
Corrosion rate of composition A.

| | |
|---|---|
| Weight | Corrosion Rate |

| Coupon | Composition | Loss (g) | mmpy | mpy |
|---|---|---|---|---|
| 1 | A | 0.0139 | 1.19 | 47 |
| 2 | A | 0.0614 | 1.32 | 52 |
| 3 | A | 0.1239 | 1.33 | 52 |

### Example 8

### Hybrid Corrosion Rate Determination Using Bar Style Coupons and Composition B

A hybrid corrosion rate study was conducted as described in Example 5 with the exception that 16.535 g of composition B was used in the test fluid. The pH of the solution was 3.75.

TABLE 6
Corrosion rate of composition B.

| | |
|---|---|
| Weight | Corrosion Rate |

| Coupon | Composition | Loss (g) | mmpy | mpy |
|---|---|---|---|---|
| 1 | B | 0.0083 | 0.71 | 28 |
| 2 | B | 0.0144 | 0.31 | 12 |
| 3 | B | 0.0241 | 0.26 | 10 |

### Example 9

### Hybrid Corrosion Rate Determination Using Bar Style Coupons and Composition F

A hybrid corrosion rate study was conducted as described in Example 5 with the exception that 43.89 g of composition F was used in the test fluid. The pH of the solution was 3.75.

TABLE 7
Corrosion rate of composition F.

| | |
|---|---|
| Weight | Corrosion Rate |

| Coupon | Composition | Loss (g) | mmpy | mpy |
|---|---|---|---|---|
| 1 | F | 0.0451 | 3.87 | 152 |
| 2 | F | 0.0531 | 1.14 | 45 |
| 3 | F | 0.0694 | 0.74 | 29 |

### Example 10

### Corrosion Rate Determination Using Bar Style Coupons, Composition B, and a Corrosion Inhibitor

A corrosion rate determination study was conducted using bar style coupons, an acid, and a corrosion inhibitor. A 15 wt. % of composition B was prepared by adding 75 g of composition B to 423 g of distilled water. To that 2.5 g of composition H was added. The solution was the added to a wide mouth plastic bottle and the coupons (Nalco P5035A) were attached evenly around a perforated cap. The bottle was capped and an airline was attached with a flow rate of 5 mL/min with 100% humidity. The study was conducted a temperature of 75° C.

TABLE 8
Corrosion rate of composition B.

| | |
|---|---|
| Weight | Corrosion Rate |

| Coupon | Composition | Loss (g) | mmpy | mpy |
|---|---|---|---|---|
| 1 | B | 0.0203 | 1.74 | 69 |
| 2 | B | 0.1939 | 4.16 | 164 |
| 3 | B | 0.5833 | 6.26 | 246 |

### Example 11

### Corrosion Rate Determination Using Bar Style Coupons and Composition E

A corrosion rate determination study was performed as described in Example 9 with the exception that 75 g composition E and 420 g of distilled water were used.

TABLE 9
Corrosion rate of composition E.

| | |
|---|---|
| Weight | Corrosion Rate |

| Coupon | Composition | Loss (g) | mmpy | mpy |
|---|---|---|---|---|
| 1 | E | 0.0234 | 2.01 | 79 |
| 2 | E | 0.4012 | 8.61 | 339 |
| 3 | E | 0.6706 | 7.20 | 283 |

### Example 12

### Corrosion Rate Determination Using Bar Style Coupons, Composition C, and a Corrosion Inhibitor

A corrosion rate determination study was performed as described in Example 9 with the exception that 75 g composition C, 5 g of composition I, and 420 g of distilled water were used.

TABLE 10
Corrosion rate of composition C.

| | |
|---|---|
| Weight | Corrosion Rate |

| Coupon | Composition | Loss (g) | mmpy | mpy |
|---|---|---|---|---|
| 1 | C | 0.4123 | 35.40 | 1394 |
| 2 | C | 1.3481 | 28.94 | 1139 |
| 3 | C | 2.0134 | 21.61 | 851 |

### Example 13

### Corrosion Rate Determination Using Bar Style Coupons, Composition C, and a Corrosion Inhibitor

A corrosion rate determination study was performed as described in Example 9 with the exception that 75 g composition C, 5 g of composition I, and 415 g of distilled water were used.

TABLE 11
Corrosion rate of composition C.

| | |
|---|---|
| Weight | Corrosion Rate |

| Coupon | Composition | Loss (g) | mmpy | mpy |
|---|---|---|---|---|
| 1 | C | 0.4155 | 35.68 | 1405 |
| 2 | C | 1.2291 | 26.38 | 1039 |
| 3 | C | 1.8319 | 19.66 | 774 |

### Example 14

### Corrosion Rate Determination Using Bar Style Coupons and Composition D

A corrosion rate determination study was performed as described in Example 9 with the exception that 75 g composition D, no corrosion inhibitor, 425 g of distilled water, and 8.24 g sodium chloride were used.

TABLE 12
Corrosion rate of composition D.

| | |
|---|---|
| Weight | Corrosion Rate |

| Coupon | Composition | Loss (g) | mmpy | mpy |
|---|---|---|---|---|
| 1 | D | 0.0079 | 0.60 | 23 |
| 2 | D | 0.0161 | 0.35 | 14 |
| 3 | D | 0.0369 | 0.40 | 16 |

### Example 15

### Corrosion Rate Determination Using Bar Style Coupons and Composition A

A corrosion rate determination study was performed as described in Example 9 with the exception that 75 g composition A, no corrosion inhibitor, 425 g of distilled water, and 4.12 g sodium chloride were used.

TABLE 13
Corrosion rate of composition A.

| | |
|---|---|
| Weight | Corrosion Rate |

| Coupon | Composition | Loss (g) | mmpy | mpy |
|---|---|---|---|---|
| 1 | A | 0.382 | 2.88 | 113 |
| 2 | A | 0.15 | 3.22 | 127 |
| 3 | A | 0.3312 | 3.55 | 140 |

### Example 16

### Corrosion Rate Determination Using Bar Style Coupons and Composition B

A corrosion rate determination study was performed as described in Example 9 with the exception that 75 g composition B, no corrosion inhibitor, 425 g of distilled water, and 4.12 g sodium chloride were used.

TABLE 14
Corrosion rate of composition B.

| | |
|---|---|
| Weight | Corrosion Rate |

| Coupon | Composition | Loss (g) | mmpy | mpy |
|---|---|---|---|---|
| 1 | B | 0.0458 | 3.45 | 136 |
| 2 | B | 0.3275 | 7.03 | 277 |
| 3 | B | 0.66 | 7.08 | 279 |

### Example 17

### Corrosion Rate Determination Using Bar Style Coupons and Composition E

A corrosion rate determination study was performed as described in Example 9 with the exception that 75 g composition E, no corrosion inhibitor, 425 g of distilled water, and 4.12 g sodium chloride were used.

TABLE 15
Corrosion rate of composition E.

| | |
|---|---|
| Weight | Corrosion Rate |

| Coupon | Composition | Loss (g) | mmpy | mpy |
|---|---|---|---|---|
| 1 | E | 0.0815 | 6.14 | 242 |
| 2 | E | 0.304 | 6.53 | 257 |
| 3 | E | 0.7726 | 8.29 | 326 |

When introducing elements of the present invention or the preferred embodiments thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above compositions and methods without departing from the scope of the invention, it is intended that all matter contained in the above description and shown in the accompanying drawings shall be interpreted as illustrative and not in a limiting sense.

1. A method for reducing the pH of an aqueous system comprising contacting an acid composition with an internal surface of a piece of equipment,
wherein the acid composition comprises a salt of a nitrogen base having a fluoro inorganic anion.

2. A method for reducing the pH of an aqueous system comprising contacting an acid composition with an aqueous mixture that contacts an internal surface of a piece of equipment,
wherein the acid composition comprises a salt of a nitrogen base having a fluoro inorganic anion.

3. The method of claim 1, wherein the aqueous system is a produced water, a feedwater, a surface water, a ground water, or a combination thereof.

4. The method of claim 1, wherein the acid composition further comprises a surfactant.

5. The method of claim 4, wherein the surfactant is a nonionic surfactant.

6. The method of claim 3, wherein the acid composition further comprises a corrosion inhibitor.

7.-9. (canceled)

10. The method of claim 1, wherein the acid composition removes inorganic deposits.

11. The method of claim 10, wherein the piece of equipment is a boiler, a steam generator, an evaporator, a heat exchanger, a tube bundle, a cooling coil, a chiller, a tank, a sump, a containment vessel, a pump, a distributor plate, a geothermal injection well, a geothermal production well, a geothermal steam separator, or a binary geothermal unit.

12. The method of claim 11, wherein the piece of equipment is an evaporator or a steam generator used in a geothermal surface system, a thermal recovery system, a sugar production system, or an ethanol production system.

13. The method of claim 11, wherein the thermal recovery system is a steam-assisted gravity drainage system, a steam flood system, or a cyclic steam stimulation system.

14. The method of claim 1, wherein the piece of equipment is a pipe, a drain line, a fluid transfer line.

15. The method of claim 1, wherein the fluoro inorganic anion is a borate or a phosphate anion.

16. The method of claim 15, wherein the fluoro inorganic anion is tetrafluoroborate, hexafluorophosphate, or a combination thereof.

17. The method of claim 16, wherein the fluoro inorganic anion comprises tetrafluoroborate.

18. The method of claim 15, wherein the nitrogen base is urea, biuret, an alkyl urea, an alkanolamine, an alkylamine, a dialkylamine, a trialkylamine, an alkyldiamine, an alkyltriamine, an alkyltetramine, a polyamine, an acrylamide, a polyacrylamide, a vinyl pyrrolidone, a polyvinyl pyrrolidone, or a combination thereof.

19. The method of claim 18, wherein the nitrogen base comprises urea.

20. The method of claim 1, wherein the fluoro inorganic anion comprises tetrafluoroborate and the nitrogen base comprises urea and the molar ratio of urea to tetrafluroboric acid used to prepare the salt is 1:3 to 3:1.

21.-22. (canceled)

23. The method of claim 1, wherein the aqueous system has a basic pH.

24. The method of claim 1, wherein the acid composition reduces corrosion of the internal surface of the piece of equipment as compared to the same method using a conventional acid composition.

25. The method of claim 1, wherein the acid composition reduces metal loss from the internal surface of the piece of equipment as compared to the same method using a conventional acid composition.
